(19) United States
(12) Patent Application Publication
(10) Pub. No.: US 2006/0231300 A1
(43) Pub. Date: Oct. 19, 2006

(54) Method for operating the brake system of a vehicle powered by electric motor, in particular a floor trolley

(76) Inventor: Peter Streipardt, Waltershausen (DE)

Correspondence Address: DAVIS & BUJOLD, P.L.L.C., 112 PLEASANT STREET, CONCORD, NH, 03301, US

(21) Appl. No.: 11/400,917

(22) Filed: Apr. 10, 2006

(30) Foreign Application Priority Data
Apr. 15, 2005 (DE) 10 2005 017 735.2

(51) Int. Cl. B62D 11/24

(52) U.S. Cl. 180/6.24

(57) ABSTRACT

A method for operating the brake system of an electric motor powered vehicle, in particular a floor trolley, in which a driving axle (1) comprises a brake mechanism for each drive output side (3, 4), is such that the two brake mechanisms of the driving axle (1) are controlled separately as a function of the steering angle in such a manner that a smaller turning circle radius (R1) is obtained by virtue of the different rotation speeds of the wheels (5, 6) of the driving axle (1).

This application claims priority from German Application Serial No. 10 2005 017 735.2 filed Apr. 15, 2005.

### FIELD OF THE INVENTION

The present invention concerns a method for operating the brake system of an electric motor powered vehicle, in particular a floor trolley, in which the driving axle has a brake mechanism for each drive output side.

### BACKGROUND OF THE INVENTION

From the prior art driving axles are known, for example, for floor trolleys such as electric counterweight fork-lifts with front-wheel drive.

In association with the known driving axles, an electric motor and a differential or distributor transmission are usually provided. Further, in this arrangement, two brake mechanisms can be provided such that one brake mechanism is used on each drive output shaft, which can, in each case, apply a corresponding braking torque on the drive output shaft.

Within the scope of DE 102 19 921 A1 by the present Applicant, a driving axle for electric motor powered vehicles is described, which comprises a brake mechanism for each drive output side without interposition of a distributor transmission. The brake mechanisms are actuated both mechanically and hydraulically by a ball ramp actuator.

In the driving axles for electric motor powered vehicles, known from the prior art, for fork-lifts with front-wheel drive, the mid-point of the turning circle is outside the track of the front wheel during braking and, disadvantageously, this results in a relatively large turning circle. This makes it difficult to drive along narrow passages; a situation that often arises when operating fork-lifts.

The purpose of the present invention is to show a method for operating the brake system of an electric motor powered vehicle, in particular a floor trolley, in which the driving axle comprises a brake mechanism for each drive output side. Thus a smaller turning circle radius results and thereby increases the maneuverability of the vehicle.

### SUMMARY OF THE INVENTION

Accordingly, a method is proposed for operating the brake system of an electric motor powered vehicle, in particular a floor trolley, in which the driving axle comprises a brake mechanism for each drive output side such that the two brake mechanisms of the driving axle are controlled separately as a function of the steering angle in such manner that a smaller turning circle radius results by virtue of the different rotation speeds of the wheels on the driving axle.

In particular, it is proposed to brake more strongly whichever wheel is closest to the mid-point of the turning circle.

According to the invention, the concept results in a smaller turning circle radius, because the mid-point of the turning circle is closer to the position of the more strongly braked wheel, respectively. In the case when a wheel is completely braked, the mid-point of the turning circle coincides with the position of the braked wheel and this gives the smallest possible turning circle radius. In this way, the maneuverability of electric motor powered vehicles, in particular fork-lifts, is optimized.

### BRIEF DESCRIPTION OF THE DRAWING

The invention will now be described, by way of example, with reference to the accompanying drawing in which:

FIG. 1 shows a comparison of the turning circle radius given by the prior art with the turning circle radius made possible by the method according to the invention.

### DETAILED DESCRIPTION OF THE INVENTION

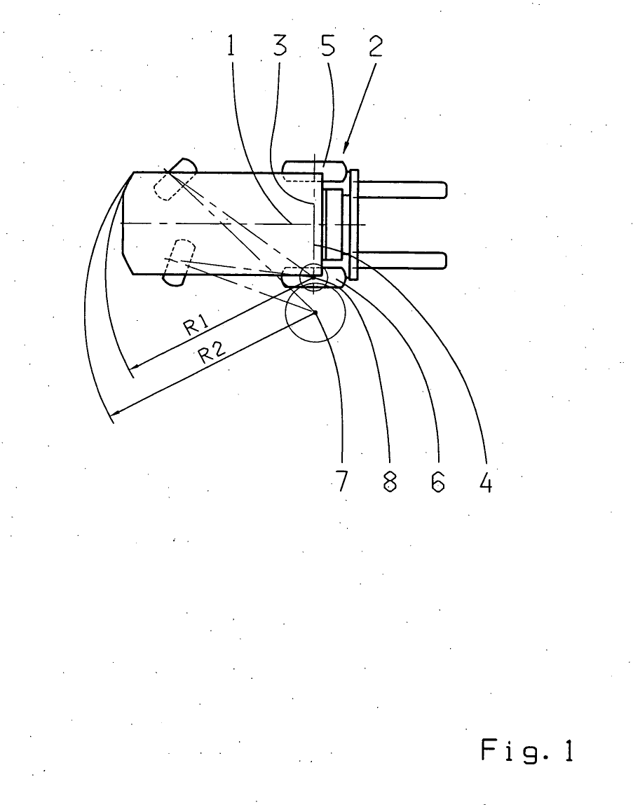

FIG. 1 shows a driving axle 1 of a fork-lift 2, which has a brake mechanism for each drive output side 3, 4 or each driven wheel 5, 6. R2 denotes the turning circle radius obtained when both of the two wheels 5, 6 are driven or braked while rounding a curve, the mid-point of this turning circle being indexed 7. When in accordance with the invention, only the wheel 6 is braked, the result is a smaller turning circle of radius R1 about a mid-point 8 (the wheel 5 rotates faster), and this significantly increases the maneuverability of the fork-lift 2.

### Reference Numerals

1 driving axle
2 fork-lift
3 drive output side
4 drive output side
5 wheel
6 wheel
7 mid-point of turning circle
8 mid-point of turning circle
R1 turning circle radius
R2 turning circle radius

1-3. (canceled)

4. A method for operating a brake system of a vehicle powered by electric motor, in particular a floor trolley, in which a driving axle comprises a brake mechanism for each drive output side, the two brake mechanisms of the driving axle (1) are controlled separately as a function of a steering angle in such manner that a smaller turning circle radius (R1) is obtained by virtue of different rotation speeds of wheels (5, 6) of the driving axle (1).

5. The method for operating the brake system of the vehicle powered by the electric motor according to claim 4, wherein a first wheel (6) closer to the mid-point of a turning circle is braked more strongly.

6. The method for operating the brake system of the vehicle powered by the electric motor according to claim 4, wherein a first wheel (6) is braked completely, so that a mid-point of a turning circle coincides with a position of the braked first wheel (6), whereby a smallest possible turning circle radius (R1) is obtained.

7. A method of operating a brake system of a vehicle powered by an electric motor, the method comprising the steps:
providing the vehicle with a driving axle having a first drive output side and a second drive output side;
providing the first drive output side with a first brake mechanism and the second drive output side with a second brake mechanism with the first brake mechanism and the second brake mechanism being independent;
controlling the first brake mechanism and the second brake mechanism independently as a function of a steering angle such that a rotational speed of the first drive output side is different than a rotational speed of the second drive output side.

8. The method of operating the brake system of the vehicle powered by the electric motor according to claim 7, further comprising the step of braking more strongly a first wheel (6) of the first drive output side when the first wheel is closer to an inside radius of a turning circle.

9. The method of operating the brake system of the vehicle powered by the electric motor according to claim 7, further comprising the step of completely braking a first wheel (6), such that a center of a turning circle coincides with a position of a completely braked first wheel (6), whereby a smallest possible turning circle radius (R1) is obtained.
